(19) United States
(12) Patent Application Publication
(10) Pub. No.: US 2013/0110751 A1
(43) Pub. Date: May 2, 2013

(54) COMPUTATIONAL DEVICE IMPLEMENTED METHOD OF SOLVING CONSTRAINED OPTIMIZATION PROBLEMS

(71) Applicants: Alaa Fathy Sheta, Amman (JO); Sultan Hamadi Aljahdali, Taif (SA); Hamza Ibrahiem Turabieh, Zarqa (JO)

(72) Inventors: Alaa Fathy Sheta, Amman (JO); Sultan Hamadi Aljahdali, Taif (SA); Hamza Ibrahiem Turabieh, Zarqa (JO)

(73) Assignee: Taif University

(21) Appl. No.: 13/621,226

(22) Filed: Sep. 15, 2012

Related U.S. Application Data
(60) Provisional application No. 61/553,734, filed on Oct. 31, 2011.

(51) Int. Cl. G06N 3/12

(52) U.S. Cl. 706/13

(57) ABSTRACT

A computational device implemented method utilizes a genetic algorithm and modifies the offspring of the genetic algorithm that fall outside of the feasible search space after crossover so that the offspring will be within the feasible search space. To place the offspring in the feasible search space, NFC and HSQPC mechanisms are used.

### CROSS-REFERENCE TO RELATED APPLICATIONS

This invention claims the priority filing date of US provisional application 61/553,734, filed Oct. 31, 2011. The contents of the priority provisional application are incorporated by reference and in its entirety.

### BACKGROUND OF THE INVENTION

1. Field of Invention

The present invention relates to a method of optimizing solutions to complex problems, more specifically a method of employing an innovative selection mechanism of genetic algorithms to solve constrained optimization problems and a system employing such optimization

2. Related Art

A genetic algorithm (GA) is a search heuristic that mimics the process of natural selection to develop the most appropriate solution. Engineers utilize nonlinear programming to develop optimization software employing GAs to help solve problems such as industrial optimization problems. The optimization software assists decision-makers in business and industry to improve organizational efficiency. Many decision-makers prefer to utilize GAs in their optimizations because the methods inherently have benefits over conventional search techniques employing gradient based methods. Linear programming solvers are rarely preferred because they often lead to abstraction and simplification of the assumptions.

One of the major advantages of GAs compared to conventional search algorithms is that they operate on a population of solutions, rather than on a single point. This makes GAs more robust and accurate. GAs are less likely to be trapped by a local optimal, unlike Newton and gradient descent methods. GAs require no derivative information about the fitness criterion. Additionally, GAs have been shown to be less sensitive to the presence of noise and uncertainty in measurements.

GAs follow a general methodology to find the optimal solution. Firstly a population is generated of potential candidate solutions. The system then compares the fitness of each candidate to the solution. The candidates having a greater fitness for the solution are selected and combined to form a new population. It is possible that when the candidates are combined that they are modified or mutated in a certain way. Various methods of modification and mutation exist. The new population is then used to repeat the same process until the software is terminated. Termination can occur after a predefined number of iterations or when a certain fitness level has been reached.

The algorithm in the system must typically contain a genetic representation of the solution domain and a fitness function to evaluate the solution domain. The fitness function is defined over the genetic representation and measures the quality of the represented solution. The fitness function is very difficult to define in many situations. The difficulty is increased because the fitness function is problem dependent. In some cases, it is extremely difficult or impossible to guess what the fitness function may be. The inability to easily and accurately define the fitness function has lead GAs to lose some effectiveness and mislead the evolutionary search. The ineffectiveness and deception can be due to such factors as the presence of many candidates in a given population being outside of the search space. In order to increase the benefit of utilizing GAs, it is preferable for the system to be as effective as possible by curtailing the population to candidates that are most suitable for assisting in finding the solution.

Evolutionary computation has shown success in managing constrained optimization problems. Evolutionary computation utilizes various methods to reject infeasible solutions. Generic algorithms (GAs) are able to handle infeasible solutions by employing a penalty function. Prior scientists found it difficult to adopt a strategy to select which of the numerous penalty functions should apply for certain problems. There are at least five commonly acceptable penalty functions for handling constraints: Homaifar, Lai, and Qi method; Joines and Houck method; Schoenauer and Zanthakis method; Michalewicz and Attia method; and Powell and Skolnuck method. Penalty functions have been arranged into three categories by those skilled in the art. The first category contains barrier penalty functions in which no infeasible solution is considered. The next category contains partial penalty functions in which a penalty is applied near to the feasibility boundary. The last category contains global penalty functions which apply penalties throughout the infeasible region.

An example of a fitness function employing a penalty function is given below

$$eval ( \overline{X} ) = \{ \begin{matrix}f ( \overline{X} ) & if \overline{X} ∈ F ⋂ S \\ f ( \overline{X} ) + penalty ( \overline{X} ) & otherwise\end{matrix}$$

where:
X̅ εS∩F.
The set S⊂Rⁿ defines the search space.
The set F⊂Rⁿ defines the feasible search space.
eval( X̅) is the fitness function of each individual.

Given the above example function, if the solution occurs within the feasible solutions, penalty( X̅) equals zero. Otherwise a penalty function that consists of a set of functions fⱼ(i≦h≦m) is used to formulate the function of penalty ( X̅). The purpose of fⱼ is to measure the violation of the j-th constraint using the following formula”

$${f}_{j} ( \overline{X} ) = \{ \begin{matrix}max \{ 0 , {g}_{i} ( \overline{X} ) \} & if 1 \leq j \leq q \\ \vert {h}_{j} ( \overline{X} ) \vert & if q + 1 \leq j \leq m\end{matrix}$$

### SUMMARY OF THE INVENTION

In one aspect a computational device implemented method of solving constrained optimization problems includes generating an initial population composed of individuals. The gintess value of each of the individuals is determined based on a fitness function. Each value is then evaluated against a convergence criterion. If none of the criterion is met, a plurality of individuals are selected and a crossover operator is applied to them. It is then determined if the operated individuals are in the feasible search domain. All feasible individuals are then mutated.

In another aspect, a computational device implemented method of solving constrained optimization problems includes running a genetic algorithm. While employing the genetic algorithm, it is determined if an offspring is in a feasible search space.

In yet another aspect, a computational device implemented method of solving constrained optimization problems includes performing a genetic algorithm. While performing the algorithm, it is determined if an offspring is not in a feasible search space. A HSQPC or a NCP mechanism is applied. The application of the mechanism may be to an offspring that was found to be outside of a feasible search space.

### BRIEF DESCRIPTION OF THE DRAWINGS

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1. is a flowchart depicting an embodiment of process implemented by the computational device;

FIG. 2 is a flowchart depicting an embodiment of the process implemented by the computational device;

FIG. 3 is an example screenshot of the GUI implemented by the system;

FIG. 4 is a graphical representation of three of the modules that may comprise the system;

FIG. 5 is a draw which helps describe how the NTT mechanism works;

FIG. 6 is a draw which helps describe how the HSQPC mechanism works; and

FIG. 7 is a schematic of the two pump system described in the example.

### DETAILED DESCRIPTION

In cooperation with the attached drawings, the technical contents and detailed description of the present invention are described thereinafter according to a preferable embodiment, not being used to limit its executing scope. Any equivalent variation and modification made according to appended claims is covered by the claims claimed by the present invention.

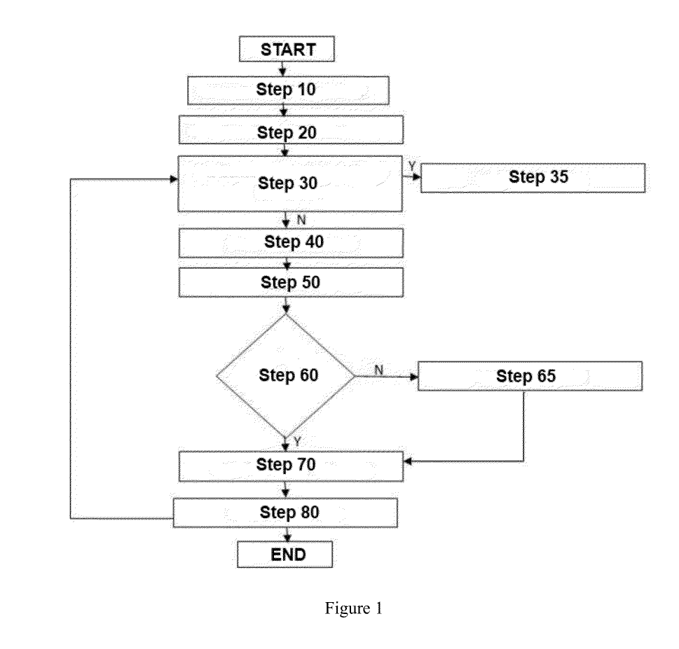

Please refer to FIG. 1. FIG. 1 is an embodiment of a program that may run on a system used for optimizing solutions of known problems. Step 10 indicates the generation of an initial population. It is important to ensure that the initial population is in the feasible search space and this can be a significant step. Before or concurrently with step 10, additional optional steps include setting the genetic algorithm parameters, setting the problem parameters, writing objective functions and constraints in files such as CONS.m, and choosing the penalty function to use. Examples of problem parameters include, but are not limited to, number of variables, variable domains, and number of inequalities. The genetic algorithm parameters include, but are not limited to, number of generations, crossover rate, and mutation rate.

FIG. 3 gives an example of a graphic user interface (GUI) showing the potential parameters that a user may input to define the solution to be solved and the genetic algorithm parameters used to solve the problem. The population size is an initial population size of individuals generated at random or heuristically. A value between 30 and 200 can be used, for example. Crossover rate is the crossover rate between two individuals. Some users may prefer values between 0.6 and 0.8. Mutation rate is the mutation rate. Some users may prefer values between 0.01 and 0.05. Number of generations is the number of iterations for the algorithm to run. Generation gap represents how many new individuals are created. Some users may choose values between 0 and 1. Selection mechanisms can be such mechanisms as stochastic universal sampling or roulette wheel selection, for example. Migrations mechanism allows a user to decide if he wants to use migration. Users may also he able to choose the crossover type. For example, the users may have a crossover type selection of single point, double point, reduced surrogate, multipoint, and shuffle point crossover. Additionally, the user may also be able to choose the algorithms used as the penalty function. Within the solution parameters, the user may solve for the minimum or the maximum of the model. The number of variables allows the user to determine how many variables the objective function has. Number of constrained allows the user to determine how many constraints the problem has. Enter the domain of variables allows the user to enter the upper and lower search space for each variable.

Step 20 determines the fitness value for each individual based on the fitness function. After performing step 20, this embodiment employs step 30. Step 30 asks if the convergence criteria have been achieved. If so, step 35 occurs by getting the best result. If not, the GA continues while the convergence criterion is not met. The GA continues by first selecting at least two individuals, step 40, and performing a crossover operation, step 50. As described above, there are various types of crossover that may be employed. The resulting offspring will either be in the feasible search space or the infeasible search space. The determination of such feasibility is step 60. If the offspring is in the infeasible search space, the infeasible solution will be processed by either an NFC or HSQPC mechanisms.

An NFC mechanism works by employing a crossover between an infeasible chromosome and the nearest feasible chromosome in the search space. The nearest chromosomes is determined by following the below formula:

Min.distance=\sqrt{(x₂−x₁)²+(y₂−y₁)²}

If the new child is located in the feasible domain, the GA mutates the child and continues on to the next generation. If the new child remains in the infeasible search domain, an additional crossover is performed utilizing the NFC mechanism. The process is repeated until the new child is in the feasible search domain. A graphical representation of how an NFC mechanism may function is provided in FIG. 5. In FIG. 5, b is located in the infeasible search domain, while a, c, and e are in the feasible domain. x is the optimal solution. The distances are defined as d₁≦d₂≦d₃. Since NFC mechanism depends on the shortest distance, a is chosen to perform a crossover with b.

A HSQPC mechanism is a type of sequential quadratic programming. Sequential quadratic programming is one of the most powerful techniques for solving complex non-linear constraint problems. Sequential quadratic programming uses a quadratic model for the objective function and a linear model for the constraint. In order to utilize HSQPC, the problem to be solved must fit the abstract pattern:

min:f(x)

St:c(x)=0

where f (x) is a function which measures the error in the least squares polynomial fit, and c(x) is a vector of non-linear constraints. Sequential quadratic programming is an iterative method which solves, at the k^{th} iteration, a quadratic program of the following form:

$$Minimize \frac{1}{2} {d}^{t} {H}_{k} d + ▽ {f ( {x}_{k} )}^{t} d$$

### Subject to:

∇hᵢ(xₖ)^{t}d+hᵢ(xₖ)=0,i=1, . . . , p

∇gᵢ(xₖ)^{t}d+gᵢ(xₖ)≦0,i=1, . . . , p

where d is defined as the search direction and hₖ is a positive definite approximation to the Hessian matrix of the Lagrangian function of the problem. The algorithm uses a pure Newton step in attempting to find the local minimum of the Lagrangian function. The Lagrangian function can be described as:

$$L ( x , γ , β ) = f ( x ) + {\sum }_{i = 1}^{p} {γ}_{i} {h}_{i} ( x ) + {\sum }_{j = p + 1}^{q} {β}_{j} {g}_{j} ( x )$$

where γ and β are the Lagrangian multipliers. The developed quadratic sub-problems can then be solved using the active set strategy. The solution xₖ at each iteration is updated according to the following equation:

xₖ₊₁=xₖ+αₖdₖ

where α is defined as the step size and takes a value in the interval [0,1]. After each iteration, the matrix Hₖ is updated based on the Newton Method. One known method to update the matrix Hₖ is the Broyden-Fletcher-Goldfarb-Shanno method. Thus:

$${H}_{k + 1} = {H}_{k} + \frac{{y}_{k} {y}_{k}^{t}}{{s}_{k} {y}_{k}^{t}} - \frac{{H}_{k} {s}_{k} {s}_{k}^{t} {H}_{k}}{{s}_{k}^{t} {H}_{k} {s}_{k}}$$

where:

sₖ=xₖ₊₁−xₖ

γₖ=∇L(xₖ₊₁,γₖ₊₁,βₖ₊₁)−∇L(xₖ₊₁,γₖ,βₖ)

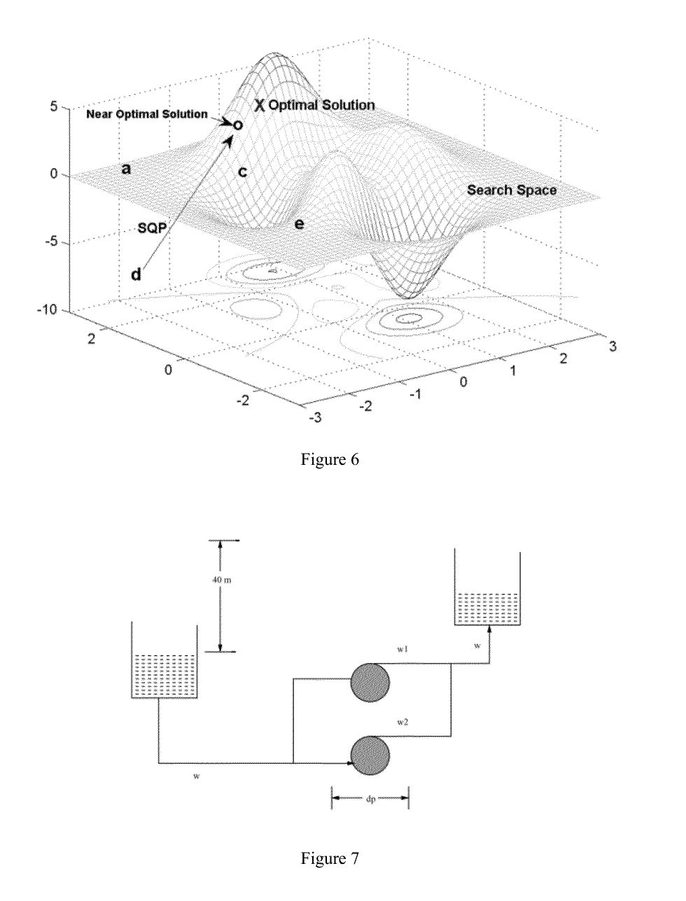

An example of a HSQPC mechanism can be seen in FIG. 6. b is located in the infeasible search domain while a, c, and e are in the feasible search domain. x is the optimal solution and o is the near optimal solution. This method is a nonobvious combination of GAs and sequential quadratic programming.

After performing step 65 to return the offspring to the feasible search space, a mutation operator is applied to the new feasible solution, step 70. Alternatively, if step 60 determined that the offspring was already in the feasible search space, the mutation operator can be directly applied, step 70, without first performing step 65. After mutation, the population is updated, step 80. The results obtained in any one simulation may be saved to a file. More specifically, the results may be saved in a Bestsofar file. This file may contain statistics about the solution of the problem after each generation. The above process continues till the stopping criterion is met or the best solution is obtained.

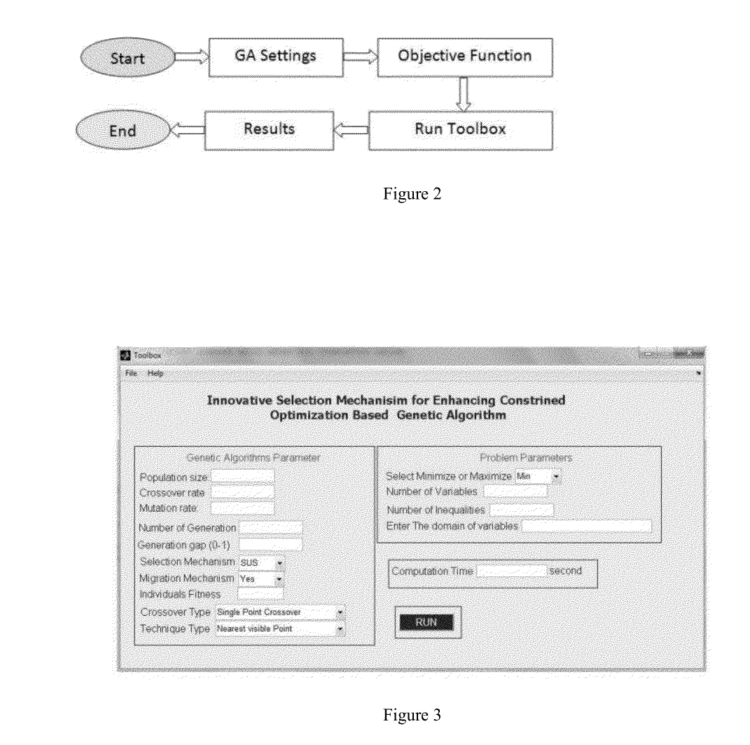

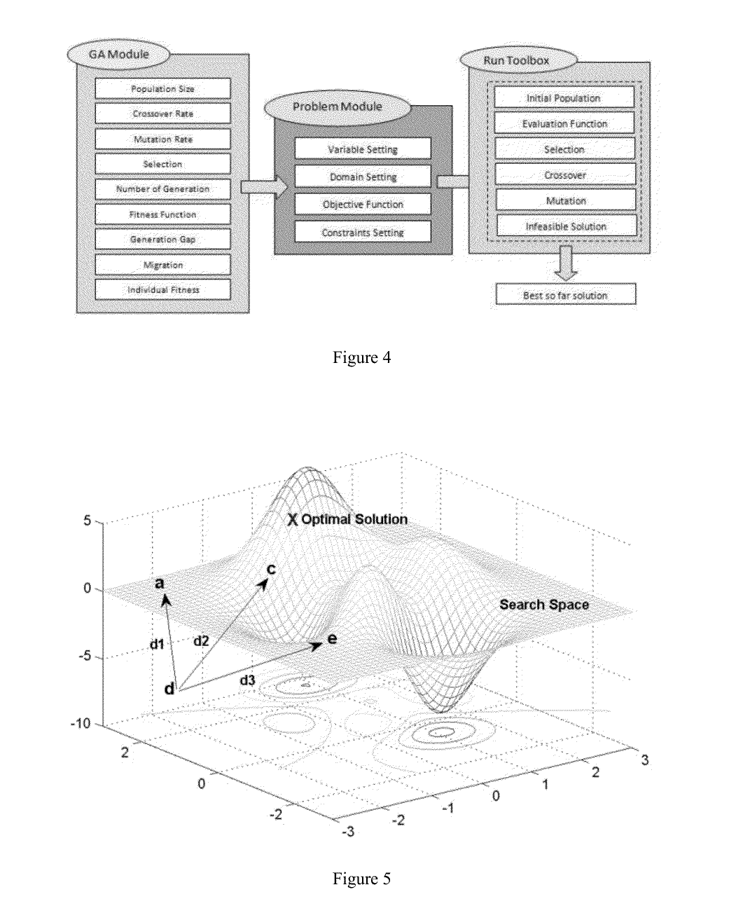

FIG. 2 depicts an embodiment of a software's main components. Utilizing these main components and the methods described above, a system implementing this software can more accurately optimize certain systems. FIG. 4 shows an embodiment of the three main modules of the software system. The user may have the option to interact with the GA module and the Problem module. The GA module performs well known GA evolutionary processes. The problem module may be used to set up the experimental environment of the problem.

### Working Example

The water pumping system is shown in FIG. 7 consists of two parallel pumps. They are used to draw water from a low lying reservoir to a higher level. In the particular example, the distance between the pumps is 40 m. It was found that the friction in the pipes of the particular example is 7.2 w² kPa. w is defined as the combined flow rate in Kg/s. The problem to be solved is to find the way to minimize the pressure difference due to elevation and friction. Mathematically, the optimization problem can be described as:

$$Min . Δ p = 7.2 {w}^{2} + \frac{( 40 m ) ( 100 K g / {m}^{3} ) ( 9.807 m / s )}{1000 Pa / kPa}$$

subject to the following restraints:

### For Pump 1:

∇p(kPa)=810−25w₁−3.754w₁²

### For Pump 2:

∇p(kPa)=900−65w₂−30w₂²

Mass balance:

w=w₁+w₂

where w₁ and w₂ are the flow rates through pump 1 and pump 2, respectively.

The water pumping system was reformulated to:

Min.f=x₃

subject to:

x₁=250+30x₁−6x₁²

x₂=300+20x₂−12x₂²

x₃=150+0.5(x₁+x₂)²

given that 0≦x₁≦9.422, 0≦x₂≦5.903, and 0≦x₃≦267.42.

Since equality constraints can be difficult to handle, it is often preferred to transfer the equality constraints into inequality constraints. This can typically be accomplished in one of two ways: 1.) eliminate some of the parameters thus reducing the dimensions of the problem; 2.) reformulate the equality to two inequalities by introducing deviation variables in the problem parameters. Thus, the above problem can be reformulated as:

Min.f=x₃=150+0.5(x₁+x₂)²

subject to:

30x₁²−249.99999+150+0.5(x₁+x₂)²

120x₂²−20x₂−249.99999+150+0.5(x₁+x₂)²≧0

Utilizing the method described in detail above, the results for such a water pumping system would be as follows:

When the penalty type is set to NCP: x₁=6.293426, x₂=3.82190, and f(x₁,x₂)=201.15996.

When the penalty type is set to SQP: x₁=6.293429, x₂=3.82183, and f(x₁,x₂)=201.15933.

What is claimed is:

1. A computational device implemented method of solving constrained optimization problems, comprising the steps of:
generating an initial population composed of individuals;
determining a fitness value for each individual based on a fitness function;
evaluating a convergence criterion of each individual;
selecting a plurality of individuals;
applying a crossover operator to the plurality of individuals;
determining if each of the plurality of individuals that have had the crossover operator applied to them is in a feasible search space;
applying a mutation operator to an individual in the feasible search space; and
updating a population to obtain an updated population.

2. The computational device implemented method of solving constrained optimization problems provided in claim 1, further comprising the step of applying a HSQPC mechanism if it is determined that that at least one of the individuals that have had the crossover operator applied to them is not in a feasible search space.

3. The computational device implemented method of solving constrained optimization problems provided in claim 2, further comprising the step of applying a second HSQPC mechanism if the previous application of the HSQPC mechanism did not produce an individual in the feasible search space.

4. The computational device implemented method of solving constrained optimization problems provided in claim 1, further comprising the step of applying an NCP mechanism if it is determined that that at least one of the individuals that have had the crossover operator applied to them is not in a feasible search space.

5. The computational device implemented method of solving constrained optimization problems provided in claim 4, further comprising the step of applying a second NCP mechanism if the previous application of the NCP mechanism did not produce an individual in the feasible search space.

6. The computational device implemented method of solving constrained optimization problems provided in claim 1, wherein the initial population must be in the feasible search space.

7. The computational device implemented method of solving constrained optimization problems provided in claim 1, further comprising the step of setting genetic algorithm parameters.

8. The computational device implemented method of solving constrained optimization problems provided in claim 1, further comprising the step of setting problem parameters.

9. The computational device implemented method of solving constrained optimization problems provided in claim 1, further comprising evaluating the updated population for satisfaction of the convergence criterion.

10. The computational device implemented method of solving constrained optimization problems provided in claim 9, further comprising the step of writing a file that contains results that will be used for statistics about a solution after each generation.

11. A computational device implemented method of solving constrained optimization problems, comprising the steps of:
running a genetic algorithm; and
determining if an offspring is in a feasible search space and does not satisfy a convergence criterion.

12. The computational device implemented method of solving constrained optimization problems provided in claim 11, further comprising the step of applying a HSQPC mechanism if it is determined that the offspring is not in the feasible search space and does not satisfy a convergence criterion to obtain an updated offspring.

13. The computational device implemented method of solving constrained optimization problems provided in claim 12, further comprising the step of applying the HSQPC mechanism to the updated offspring if the updated offspring is not in the feasible search space.

14. The computational device implemented method of solving constrained optimization problems provided in claim 11, further comprising applying a NCP mechanism if it is determined that the offspring is not in the feasible search space and does not satisfy a convergence criterion to obtain an updated offspring.

15. The computational device implemented method of solving constrained optimization problems provided in claim 14, further comprising the step of applying the NCP mechanism to the updated offspring if the updated offspring is not in the feasible search space.

16. The computational device implemented method of solving constrained optimization problems provided in claim 11, wherein an initial population of the genetic algorithm is in the feasible search space.

17. The computational device implemented method of solving constrained optimization problems provided in claim 11, further comprising setting the genetic algorithm parameters.

18. The computational device implemented method of solving constrained optimization problems provided in claim 11, further comprising setting the problem parameters.

19. A computational device implemented method of solving constrained optimization problems, comprising the steps of:
running a genetic algorithm;
determining an offspring is not in a feasible search space and does not satisfy a convergence criterion; and
applying either a HSQPC mechanism or a NCP mechanism.

20. The computational device implemented method of solving constrained optimization problems described in claim 19, wherein an initial population of the genetic algorithm is in the feasible search space.
